(19) United States
(12) Patent Application Publication
(10) Pub. No.: US 2023/0012864 A1
(43) Pub. Date: Jan. 19, 2023

(54) JOINT MECHANISM

(71) Applicant: BOGAZICI UNIVERSITESI, Istanbul (TR)

(72) Inventors: Cetin YILMAZ, Istanbul (TR); Ahmet Onur OZYAR, Norrkoping (SE)

(73) Assignee: BOGAZICI UNIVERSITESI, Istanbul (TR)

(21) Appl. No.: 17/785,413

(22) PCT Filed: Dec. 15, 2020
(86) PCT No.: PCT/TR2020/051301

§ 371 Date: Jun. 15, 2022

(30) Foreign Application Priority Data
Dec. 16, 2019 (TR) 2019/20296

(51) Int. Cl. F16F 7/104

(52) U.S. Cl. CPC F16F 7/104; F16F 2222/08; F16F 2228/066; F16F 2230/0005

(57) ABSTRACT

A joint mechanism comprises at least one body, at least one first roller and at least one second roller mutually positioned on said body and is configured to move any one of said first roller and second roller towards the other so as to allow a beam used particularly in vibration isolation mechanisms to translate along at least one first axis. The body has at least one first part and at least one second part essentially adjacent to each other and said first part and said second part are engaged by means of at least one first flexible element in a manner such that they allow at least partial movement with respect to each other, so as to allow said beam to be rotated at least partially around at least one rotating point in the direction of at least one second axis.

### TECHNICAL FIELD

The invention particularly relates to at least one joint mechanism that comprises at least one body, at least one first roller and at least one second roller mutually positioned on said body and is configured to move any one of said first roller and second roller towards the other so as to allow a beam used particularly in vibration isolation mechanisms to move along at least one first axis at least partially.

### PRIOR ART

The joint is a mechanical structure that provides at least one of at least two parts to be connected to each other allowing relative motion between parts. The joints can vary according to the allowable degrees of freedom and direction of movement. The most common ones are cylindrical joints, spherical joints and sliding joints. Cylindrical joints allow two degrees of freedom, spherical joints allow three degrees of freedom, and sliding joints allow one degree of freedom.

Each of the joint mechanisms used in the state of the art are produced individually and it is not seen that a plurality of joint mechanism with the same function are integrated. For this reason, freedom of movement cannot be provided in the linear axis and rotary axis together. Although there are flexible joint designs that can provide rotation about a virtual point, however, these designs do not include a sliding connection.

Since the sliding joint and the rotary joint do not take place together, this prevents their use in robotic applications or telescopically connected arms (in systems where rotation around a certain axis is allowed but telescopic movement in a vertical axis is also required). Besides, high precision cannot be obtained in applications such as ultrasonic motors or impact motors etc. where dynamic or impact excitation is provided.

As a result, all abovementioned problems have made it necessary to make an improvement in the relevant technical field.

### BRIEF DESCRIPTION OF THE INVENTION

The present invention is related to a joint mechanism, in order to eliminate the abovementioned disadvantages and to bring new advantages to the relevant technical field.

An object of the invention is to provide a joint mechanism with increased movement capability.

The invention is at least one joint mechanism that comprises at least one body, at least one first roller and at least one second roller mutually positioned on said body and is configured to move any one of said first roller and second roller towards the other so as to allow a beam used particularly in vibration isolation mechanisms to move the same along at least one first axis at least partially so as to fulfill all aims mentioned above and obtained from the following detailed description. The novelty herein is that; the body has at least one first part and at least one second part essentially adjacent to each other and said first part and said second part is engaged by means of at least one first flexible element in a manner such that they allow at least partial movement with respect to each other, so as to allow said beam to be rotated at least partially about a rotating point in the direction of at least one second axis. Therefore, the beam which can translate in the direction of the first axis can also rotate at least partially in the second axis direction.

A possible embodiment of the invention is characterized in that; said first flexible element is mainly a leaf spring. Therefore, a durable structure is obtained by preventing the plastic deformation of the joint at high forces.

A possible embodiment of the invention is characterized in that; at least two first flexible elements are provided mutually between the first part and the second part. Therefore, the first part is able to rotate at least partially in two directions with respect to the second part in a flexible manner.

A possible embodiment of the invention is characterized in that; the intersection point of the extensions of the first flexible elements forms said rotating point. Thus, the rotating point for moving the beam in the second axis direction is the center of rotation of the beam.

A possible embodiment of the invention is characterized in that; the first part and second part are connected with each other through said flexible element. Therefore, positioning the first flexible element in the first part and the second part in a fixed manner is enabled.

A possible embodiment of the invention is characterized in that; there is at least one space between the first part and the second part so as to allow the elastic deformation of the first elastic member. Therefore, when the first part moves relative to each other, the first part and the second part can get closer to or get away from each other.

A possible embodiment of the invention is characterized in that; at least one third roller is positioned mainly on the second roller side on the first part of the body. Therefore, stability is provided during the linear movement of the beam in the first axis.

### BRIEF DESCRIPTION OF DRAWINGS

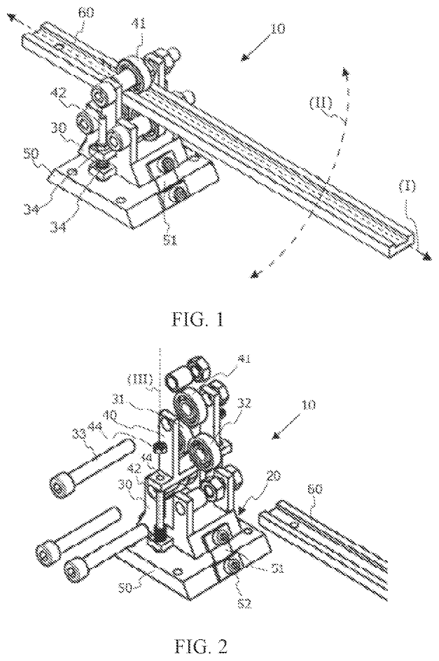

An illustrative perspective view of the inventive joint mechanism is given in FIG. 1.

An illustrative exploded view of the inventive joint mechanism is given in FIG. 2.

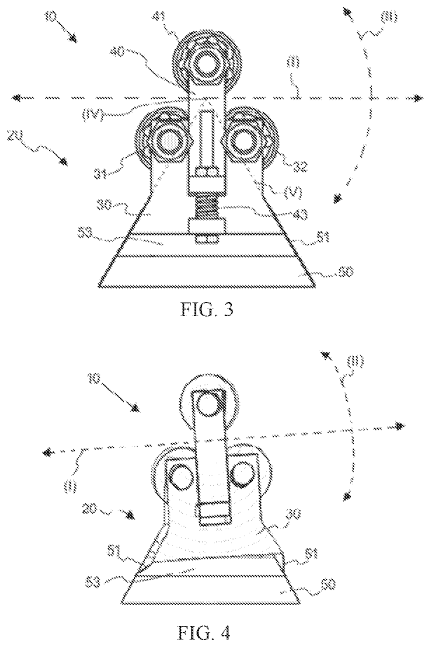

An illustrative side view of the inventive joint mechanism is given in FIG. 3.

An illustrative side view showing the elastic deformation of the inventive joint mechanism under force is given in FIG. 4.

### DETAILED DESCRIPTION OF THE INVENTION

In this detailed description, the subject of the invention is described by means of examples only for clarifying the subject matter such that no limiting effect is created.

An illustrative perspective view of the inventive joint mechanism (10) is given in FIG. 1. Thus, said joint mechanism (10) is configured so as to allow at least one beam (60) that is used in vibration isolation systems to translate along one first axis (I) and rotate at least partially along the direction of one second axis (II). As mentioned above, said joint mechanism (10) can be used in fields in machine designs where flexible and sliding connections are required such as medicine, transportation, military, robotic technologies, and particularly in vibration isolation systems.

An illustrative exploded view of the inventive joint mechanism (10) is given in FIG. 2. Thus, in the joint mechanism (10), at least one body (20) having at least one first part (30) and at least one second part (50) is positioned. In the first part (30) of said body (20), at least one first roller (41) and at least one second roller (31) is positioned in a manner such that they allow the beam (60) to pass between them and to translate in the direction of said first axis (I). In a possible embodiment of the invention, mainly at least one third roller (32) is also positioned on the side of the second roller (31). Said first roller (41), second roller (31) and third roller (32) are essentially roller bearings so as to minimize the friction force during the linear movement of the beam (60) along the first axis (I). On the other hand, instead of a roller bearing, sliding or lubricated bearing roller can be used so as to minimize the friction force. Said rollers may have different shapes based on the shape of the beam (60). In case the beam has circular cross section, the surfaces of the rollers that contact the beam are grooved so as to grasp the beam.

In a possible embodiment of the invention, said first roller (41) is configured on the body (20) in a manner such that it can move towards the second roller (31) and the third roller (32) on at least one compression axis (III). In order to realize this, the first roller (41) is positioned on at least one sliding bracket (40). Said sliding bracket (40) is connected to the first part (30) of the body (20) in a manner such that it can move on the compression axis (III). At least one compression bolt (42) is used so as to engage the sliding bracket (40) and the first part (30) of the body (20). Said compression bolt (42) is mainly fixed by means of at least one nut (44) by being passed through at least one connection hole (34) positioned on the first part (30) and the sliding bracket (40). The nut (44) can be located on the desired location by rotating the same on the threads (not shown in the figures) on the compression bolt (42). Therefore, the compression bolt (42) is provided so as to position the sliding bracket (40) at the desired location of the first part (30). The compression nut (44) compresses the sliding bracket (40) on the compression bolt (42), thus restricts its distance from the first part (30). At least one second flexible element (43) is located on the compression bolt (42) between the connection holes (34). Said second flexible member (43) is a helical spring that creates a compression force so as to enable the sliding bracket (40) and the first part (30) to move away from each other. This compression force can also be formed by a leaf spring or a different shaped flexible element instead of the helical spring. While the first roller (41) is brought closer to the second and third rollers (32) by means of the nut (44), the second flexible element (43) allows the beam (60) to move without any backlash on the first axis (I) by exerting a force in the opposite direction. Thus, even if the joint mechanism (10) is subjected to vibration, no backlash is formed owing to the compression force on the beam (60), and as a consequence, no rattling occurs.

At least one roller shaft (33) is used in positioning the first roller (41) on the sliding bracket (40) and the second roller (31) and the third roller (32) on the first part (30) of the body (20).

Said roller shaft (33) provides the rollers to be positioned at predetermined locations by passing through the rollers. Thus, its high-strength leads to a durable structure.

An illustrative side view of the inventive joint mechanism (10) is given in FIG. 3. Thus, said joint mechanism (10) is configured so as to allow the beam (60) to rotate around one rotating point (IV) along the direction of one second axis (II) at least partially. In order to realize this, the first part (30) and the second part (50) on the body (20) are connected to each other by means of at least one first flexible element (51). In a possible embodiment of the invention, said first flexible member (51) is at least one leaf spring and is connected to the first part (30) and the second part (50) by means of at least one connection element (52). In the joint mechanism (10), the point where essentially the alignment of the first roller (41) with the second roller (31) and the third roller (32) and the extension directions (V) of the first flexible elements (51) intersect is said rotating point (IV).

An illustrative side view showing the deformation of the inventive joint mechanism (10) under force is given in FIG. 4. Thus, the beam (60) is rotated about the rotation point (IV) along the direction of the second axis (II) at least partially under force loading. When the beam (60) is rotated about the rotation point (IV) along the direction of the second axis (II), the first part (30) moves at least partially relative to the second part (50). This movement is provided by at least partially elastic deformation of the first flexible elements (51). As soon as the load on the beam (60) is removed, the first part (30) returns to its original form. In addition, while the first part (30) and the second part (50) are connected to each other, at least one space (53) is left between them. Said space (53) provides gap for movement to the first flexible members (51) so as to allow the first part (30) and the second part (50) to move at least partially relative to each other.

In a preferred embodiment of the invention, the beam (60) is engaged between the first roller (41) and the second roller (31) and the third roller (32) in the joint mechanism (10). It is ensured that the beam (60) of the first roller (41) presses tightly towards the second roller (31) and the third roller (32) by tightening the compression bolt (42) by means of the nut (44) so as to move the beam (60) backlash-free in the direction of the first axis (I) and the second axis (II). Subsequently, while the beam (60) is used in any place, after it is subjected to force; the beam (60) can slide in the first axis (I) relative to the first part (30). Moreover, the beam (60) can be held from the rotation point (IV) and is provided to rotate at least partially in the direction of the second axis (II). Therefore, the beam (60) is provided to perform two different movements simultaneously.

Together with all of these embodiments; while the degree of freedom is provided to the joint mechanism (10) in two axes, the beam (60) is allowed to move backlash-free in the body (20) despite the environmental conditions (vibration, quake etc.) during these movements. Therefore, high precision can be obtained in applications such as ultrasonic motors or impact motors etc. where dynamic or impact excitation is provided.

The protection scope of the invention is specified in the appended claims and cannot be limited to the description made for illustrative purposes in this detailed description. Likewise, it is clear that a person skilled in the art can present similar embodiments in the light of the above descriptions without departing from the main theme of the invention.

### REFERENCE NUMBERS

10 Joint Mechanism
20 Body
30 First Part
31 Second Roller
32 Third Roller
33 Roller Shaft
34 Connection Hole
40 Sliding Bracket
41 First Roller
42 Compression Bolt
43 Second Flexible Element
44 Nut
50 Second Part
51 First Flexible Element
52 Connection Element
53 Space
60 Beam
(I) First Axis
(II) Second Axis
(III) Compression Axis
(IV) Rotating Point
(V) Extension Direction

1. A joint mechanism, comprising at least one body, at least one first roller and at least one second roller, wherein
the at least one first roller and the at least one second roller are mutually positioned on the at least one body, any one of the at least one first roller and the at least one second roller is moved towards the other to allow a beam to translate along at least one first axis, and the beam is used particularly in vibration isolation mechanisms;
the at least one body has comprises at least one first part and at least one second part, wherein the at least one first part and the at least one second part are essentially adjacent to each other; and
the at least one first part and the at least one second part are engaged by at least one first flexible element in a manner of allowing at least partial movement with respect to each other, to allow the beam to be rotated at least partially around at least one rotating point around a direction of at least one second axis.

2. The joint mechanism according to claim 1, wherein the at least one first flexible element is a leaf spring.

3. The joint mechanism according to claim 2, wherein at least two first flexible elements are provided mutually between the at least one first part and the at least one second part.

4. The joint mechanism according to claim 3, wherein extension directions of the at least two first flexible elements on the at least one first part and the at least one second part are engaged with each other in a manner of intersecting at the at least one rotating point.

5. The joint mechanism according to claim 1, wherein the at least one first part and the at least one second part are connected with each other through the at least one first flexible element.

6. The joint mechanism according to claim 1, wherein at least one space is provided between the at least one first part and the at least one second part to allow elastic deformation of the at least one first flexible element.

7. The joint mechanism according to claim 1, wherein at least one third roller is positioned on a side of the at least one second roller on the at least one first part of the at least one body.
